(19) United States
(12) Patent Application Publication
(10) Pub. No.: US 2014/0090984 A1
(43) Pub. Date: Apr. 3, 2014

(54) SYSTEMS AND METHODS FOR STEREOSCOPIC IMAGING OF ALUMINUM ELECTROLYSIS POT TENDING OPERATIONS

(71) Applicant: ALCOA INC., Pittsburgh, PA (US)

(72) Inventors: Gilles Dufour, Quebec (CA); Jean-Pierre Gagne, Saguenay (CA); Harold Frenette, St-Augustin de Desmaures (CA); Rene Trudel, St-Raymond (CA)

(73) Assignee: ALCOA INC., Pittsburgh, PA (US)

(21) Appl. No.: 13/785,864

(22) Filed: Mar. 5, 2013

Related U.S. Application Data
(60) Provisional application No. 61/708,465, filed on Oct. 1, 2012.

(51) Int. Cl. C25C 7/06; H04N 13/02; C25C 3/06

(52) U.S. Cl. CPC C25C 7/06; C25C 3/06; H04N 13/0239
USPC 205/336; 348/47

(57) ABSTRACT

Systems and methods for stereoscopic imaging and viewing of aluminum electrolysis and related operation and/or maintenance activities are disclosed. The system may produce stereoscopic images based at least in part on images obtained from two or more imaging devices. The system may display the stereoscopic images for viewing to facilitate aluminum electrolysis cell operation and/or maintenance.

### CROSS REFERENCE TO RELATED APPLICATION

This patent application claims priority to U.S. Provisional Patent Application No. 61/708,465, entitled “SYSTEMS AND METHODS FOR STEREOSCOPIC IMAGING OF ALUMINUM ELECTROLYSIS POT TENDING OPERATIONS”, filed Oct. 1, 2012, and which is incorporated herein by reference in its entirety.

### BACKGROUND

Production of aluminum by electrolysis takes place in aluminum electrolysis cells. Various tasks are required to operate and/or maintain these aluminum electrolysis cells.

### SUMMARY OF THE DISCLOSURE

Broadly, the present disclosure relates to systems and methods for stereoscopic imaging of aluminum electrolysis pot tending operations. In one approach, a method includes the steps of (a) passing electric current from an anode to a cathode via a molten bath in an aluminum electrolysis pot, thereby producing aluminum metal in the electrolysis pot, (b) performing at least one pot tending operation in the aluminum electrolysis pot, (c) obtaining first and second images of the performing step (b) via an imaging system, and (d) producing, in response to the obtaining step (c), at least one stereoscopic image, based at least in part on the first and the second images. The obtaining step (c) includes first obtaining a first image of the pot tending operation via a first imaging device aimed at an imaging target, wherein the first imaging device has a first imaging axis contained in a first vertical plane, and (ii) second obtaining a second image of the pot tending operation via a second imaging device aimed at the imaging target, wherein the second imaging device has a second imaging axis contained in a second vertical plane, (iii) wherein the first and second vertical planes intersect proximal the imaging target, and (iv) wherein the angle between the first vertical plane and the second vertical plane is between 0.01 degrees and 10 degrees. Such an arrangement may facilitate the production of stereoscopic images. In one embodiment, the producing step (d) comprises displaying at least one stereoscopic image on a display for viewing by one or more operators.

The imaged pot tending operation may be any pot tending operation suited for imaging. In one embodiment, the pot tending operation comprises removing at least one anode from the aluminum electrolysis cell. In one embodiment, the pot tending operation comprises breaking the crust of the aluminum electrolysis cell. In one embodiment, the pot tending operation comprises raising at least one anode out of the molten bath of the aluminum electrolysis cell. In some of these embodiments, the anode is a first anode, and the pot tending operation comprises removing this first anode from the aluminum electrolysis pot. In some of these embodiments, the method includes inserting a second anode into the aluminum electrolysis pot and/or covering the second anode with alumina.

In one embodiment, a method includes moving at least the first imaging device of the imaging system from a first imaging position to a second imaging position to facilitate the obtaining step (c), where the first imaging position is associated with a first body position of an operator, and where the second imaging position is associated with a second body position of the operator. In one embodiment, a method includes moving the first imaging device from a first imaging position to a second imaging position, and moving the second imaging device from a third imaging position to a forth imaging position to facilitate the obtaining step (c), where the first and third imaging positions are associated with a first body position of an operator, and where the second and fourth imaging positions are associated with a second body position of the operator. In one embodiment, a moving step comprises translating the imaging device in at least one of an x, y, and z direction. In one embodiment, a moving step comprises rotating the imaging device about an axis. In one embodiment, the moving step is a second moving step, and the method include first moving a body part of the operator from the first body position to the second body position. This method may further include one or more of detecting the first and second body positions via a body tracking system, producing body position information in response to the detecting step, communicating the body position information to a controller associated with the imaging system, and completing the second moving step. In one embodiment, the body part is the head of an operator. In one embodiment, the producing step (d) includes displaying the stereoscopic image on a display for viewing by the operator, wherein the display is a part of the body tracking device.

In one embodiment, a method includes changing the field of view of at least a first imaging device from a first field of view to a second field of view to facilitate the obtaining step (c). In one embodiment, the first field of view is associated with a third body position of an operator, and the second field of view is associated with a fourth body position of the operator.

In yet another approach, a method includes (a) passing electric current from an anode to a cathode via a molten bath in an aluminum electrolysis pot, thereby producing aluminum metal in the aluminum electrolysis pot, (b) performing at least one pot tending operation in the aluminum electrolysis pot, (c) obtaining images of the performing step (b) via an imaging system; wherein the obtaining step (c) comprises: (i) first obtaining a first image of the pot tending operation via a first imaging device aimed at an imaging target, wherein the first imaging device has a first imaging axis contained in a first vertical plane; (ii) second obtaining a second image of the pot tending operation via a second imaging device aimed at the imaging target, wherein the second imaging device has a second imaging axis contained in a second vertical plane; (iii) wherein the first vertical plane is parallel to the second vertical plane; and (d) producing, in response to the obtaining step (c), a stereoscopic image, based at least in part on the first and the second images. This method may also include the above-described display device and/or body tracking system.

Systems for stereoscope imaging of pot tending operations are also provided. In one approach a system includes (a) an imaging system having (i) a first imaging device operable to obtain a first image of a pot tending operation, wherein the first imaging device has a first imaging axis contained in first vertical plane; and (ii) a second imaging device operable to obtain a second image of at least a portion of the aluminum electrolysis pot, wherein the second imaging device has a second imaging axis contained in a second vertical plane; (iii) wherein the first and second vertical planes intersect proximal an imaging target; (iv) wherein the angle between the first vertical plane and the second vertical plane is between 0.01 degrees and 10 degrees. The system may further include (b) an image processor, in electronic communication with the imaging system, wherein the imaging system is operable to produce a stereoscopic image based at least in part on the first and the second images. The first and second imaging devices may be separate or integral. In one embodiment, the first imaging device is integral to the second imaging device. In another embodiment, the first imaging device is separate from (non-integral to) the second imaging device.

The system may include a display device in electronic communication with the image processor and operable to display the stereoscopic image to an operator. The system may include a body tracking system adapted to detect body positions of an operator and produce corresponding body position information. The system may include a controller in electronic communication with the body tracking system, wherein the controller is operable to produce control signals in response to the body position information. The imaging system may include (i) an imaging device mount interconnected to at least the first imaging device, wherein the imaging device mount is moveable; and (ii) a motorized device interconnected to the imaging device mount and in electronic communication with the controller, wherein the motorized device is adapted to move the mount in response to the control signals, and thereby move at least the first imaging device from a first imaging position to a second imaging position, wherein the first imaging position is associated with a first body position of the operator, and wherein the second imaging position is associated with a second body position of the operator. In one embodiment, the display device is a part of the body tracking device. In another embodiment, the display device is separate from any body tracking device.

In another approach, a system includes (a) an imaging system comprising (i) a first imaging device operable to obtain a first image of a pot tending operation, wherein the first imaging device has a first imaging axis contained in first vertical plane; and (ii) a second imaging device operable to obtain a second image of at least a portion of the aluminum electrolysis pot, wherein the second imaging device has a second imaging axis contained in a second vertical plane; (iii) wherein the first vertical plane is parallel to the second vertical plane. The system may further include (b) an image processor, in electronic communication with the imaging system, wherein the imaging system is operable to produce a stereoscopic image, based at least in part on the first and the second images. The system may also include the above-described display device and/or body tracking system.

These and other aspects and advantages, and novel features of this new technology are set forth in part in the description that follows and will become apparent to those skilled in the art upon examination of the following description and figures, or may be learned by practicing one or more embodiments of the technology provided for by the present disclosure.

### BRIEF DESCRIPTION OF THE DRAWINGS

FIG. 1 is a schematic illustration of one embodiment of a system for stereoscopic imaging and viewing of aluminum electrolysis pot tending operations.

FIG. 2a is a schematic illustration of one embodiment of the imaging system of FIG. 1.

FIG. 2b is an illustration of one embodiment of an arrangement of imaging devices.

FIG. 2c is an illustration of an alternative embodiment of an arrangement of imaging devices.

FIG. 3 is an illustration of one embodiment of an imaging device mount.

FIG. 4 is a schematic illustration of another embodiment of a system for stereoscopic imaging and viewing of aluminum electrolysis pot tending operations, wherein the imaging system is controlled by body movements of an operator.

FIG. 5 is a schematic illustration of one embodiment of the body tracking system of FIG. 4.

FIG. 6 is an illustration of one embodiment of a stereoscopic camera.

### DETAILED DESCRIPTION

Reference will now be made in detail to the accompanying drawings, which at least assist in illustrating various pertinent embodiments of the new technology provided for by the present disclosure.

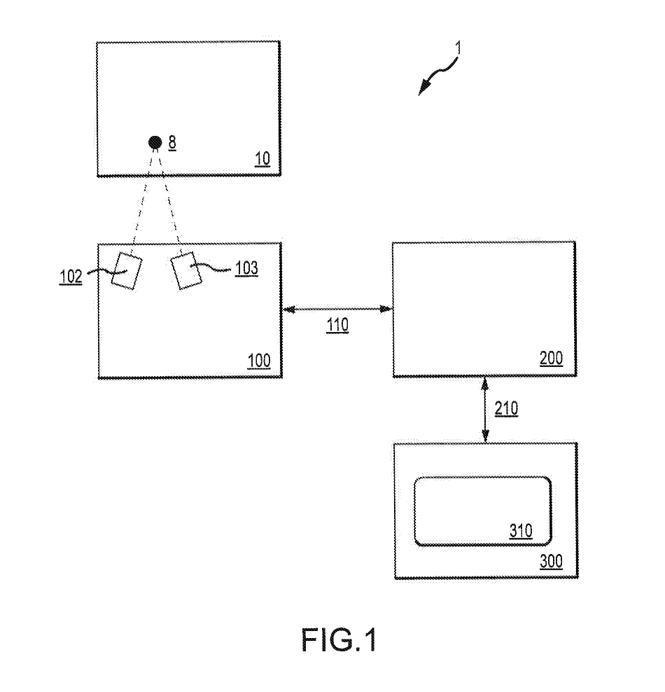

Referring now to FIG. 1, one embodiment of a system 1 for producing stereoscopic images to facilitate the operation and/or maintenance of aluminum electrolysis cells is illustrated. The illustrated system 1 comprises an aluminum electrolysis cell 10, an imaging target 8 associated with the aluminum electrolysis cell 10, an imaging system 100, an image processor 200, and a display device 300. The imaging system 100 is in electronic communication 110 with the image processor 200, and the image processor 200 is in electronic communication 210 with the display device 300.

In the illustrated embodiment, the imaging system 100 comprises a first imaging device 102 and a second imaging device 103. The first imaging device 102 is operable to obtain a first image of the imaging target 8. The second imaging device 103 is operable to obtain a second image of the imaging target 8. The image processor 200 is operable to receive, via electronic communication 110 (e.g., wired and/or wireless electronic communication), the first and second images from the imaging system 100 and produce one or more stereoscopic image(s) 310 (hereinafter “stereoscopic images(s)”) of the imaging target 8, based at least in part on the first and second images. As used herein, “stereoscopic image(s)” is/are a visual representation of the three-dimensional (i.e., respecting the x, y, and z spatial dimensions) configuration of matter and/or objects based at least part on a first and a second image, wherein the first image is taken from a different perspective than the second. These stereoscopic image(s) 310 may be displayed via display device 300, which may facilitate the operation and/or maintenance of the aluminum electrolysis cell 10. For example, the display of stereoscopic image(s) 310 of the interior of the aluminum electrolysis cell 10 may facilitate the removal and/or replacement of an anode from the aluminum electrolysis cell 10 by allowing the operator, for instance, in a location remote to the aluminum electrolysis cell 10, to visualize the removal and/or replacement operation, and in three dimensions. Additionally, display of stereoscopic image(s) 310 may facilitate other operations performed in relation to the aluminum electrolysis cell 10, sometimes referred to herein as “pot tending operations,” including breaking the crust of an aluminum electrolysis cell, raising a first anode out of the molten bath of an aluminum electrolysis cell, removing the first anode, scooping up the broken crust, inserting a second anode into an aluminum electrolysis cell, and covering the second anode with alumina, to name a few. In one embodiment, one or more of these pot tending operations is performed using a pot tending machine (“PTM”).

The display device 300 may be located remote of the imaging system 100 and/or the image processor 200. In one embodiment, the display device 300 is associated with (e.g., located in; mounted to) a PTM. The display device 300 is operable to receive and display the stereoscopic image(s) 310. In one embodiment, the display device 300 may display the stereoscopic image(s) 310 for viewing (e.g., by an operator). The display device 300 may receive the stereoscopic image(s) 310 from the image processor 200 via electronic communication 210. Electronic communication 210 may occur over a wireless and/or wired network. In one embodiment, the display device 300 may be a separate component of the system. In one embodiment, the image processor 200 may be a separate component of the system. In one embodiment, the display device 300 may comprise the image processor 200 and/or the imaging system 100.

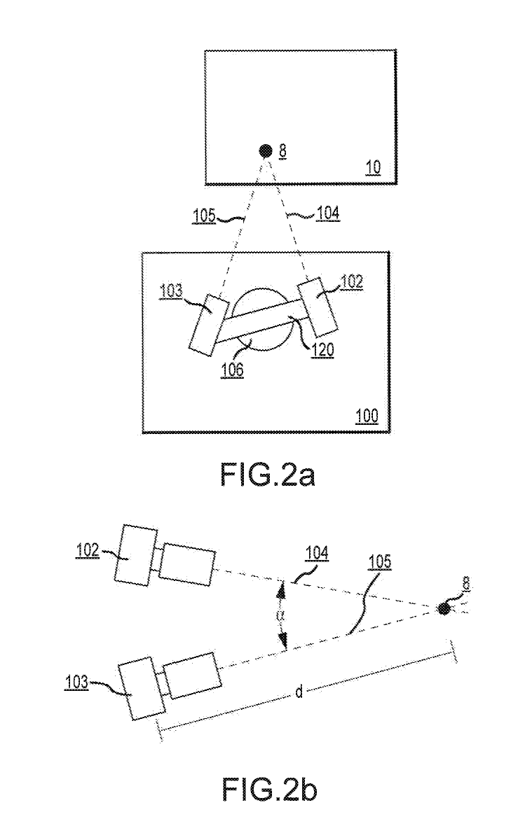

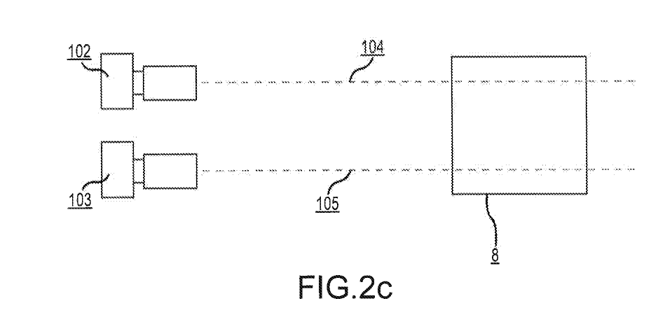

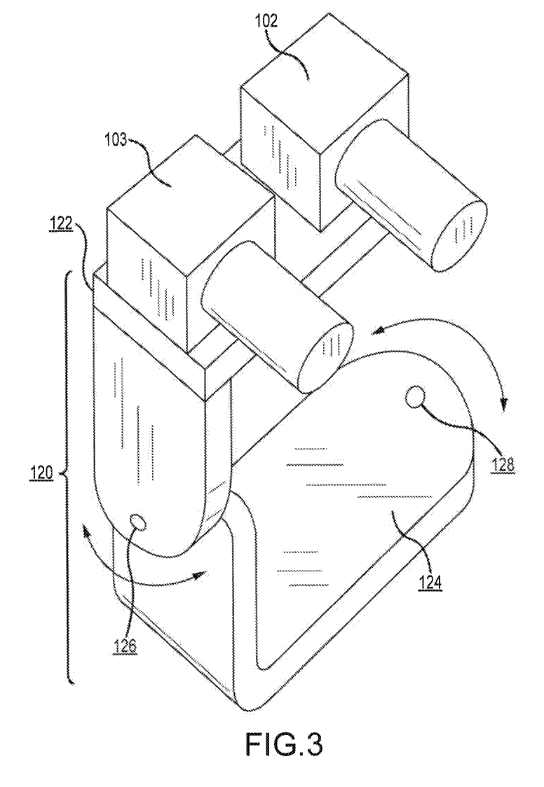

As used herein, an “imaging system” is a system adapted to obtain an image of at least a portion of an electrolysis cell from at least a first imaging position and a second imaging position, wherein the first is a different position then the second. Referring now to FIGS. 2a, 2b, 2c, and 3, the imaging system 100 may comprise a first imaging device 102 and a second imaging device 103. As used herein, an “imaging device” is a device adapted to obtain an image of an electrolysis cell. For example, the imaging device may comprise one or more digital or analog imaging devices. In turn, the image or images may be in a binary or analog format. In one embodiment, the first and second imaging devices 102, 103 are digital imaging devices and the images are digital images. The imaging system 100 may be operable to move at least one of the first and second imaging devices 102, 103. The moving may comprise, for example, rotating and/or translating an imaging device. As used herein, “translating” is changing the position of an object in space without rotation. In one embodiment, the imaging system 100 may be a separate component of the system. In one embodiment, the imaging system 100 may comprise the image processor 200 and/or the display device 300.

The first imaging device 102 has a first imaging axis 104 and the second imaging device 103 has a second imaging axis 105. As used herein, the “imaging axis” of an imaging device is an axis that extends from the focal point of the imaging device and through the imaging target. In one embodiment, the imaging axis is the optical axis (i.e., the line that passes through the center of curvature of the lens surface) of a camera lens. The first imaging axis 104 is contained in a first vertical plane (extending out of the page in FIGS. 2a, 2b, and 2c). Similarly, the second imaging axis 105 is contained in a second vertical plane (extending out of the page in FIGS. 2a, 2b, and 2c).

In one embodiment, and as illustrated in FIGS. 2a and 2b, the first and second imaging devices 102, 103 may be positioned such that the first and the second vertical planes intersect proximal the imaging target 8 to form angle n. Stereoscopic image(s) useful in accordance with this embodiment may be produced using an angle α of from 0.01 to 10 degrees. In one embodiment, the angle α may be not greater than 9 degrees. In other embodiments, the angle α may be not greater than 8 degrees, or not greater than 7 degrees, or not greater than 6 degrees, or not greater than 5 degrees, or less. In one embodiment, the angle α may be at least 0.1 degrees. In other embodiments, the angle α may be at least 0.2 degrees, or at least 0.3 degrees, or at least 0.4 degrees, or at least 0.5 degrees, or more.

In another embodiment, and as illustrated in FIG. 2c, the first and second imaging devices 102, 103 may be positioned such that the first vertical plane is parallel to the second vertical plane. Stereoscopic image(s) useful in accordance with this embodiment may be produced via software such as StereoPhoto Maker.

In the illustrated embodiment of FIG. 2a, the imaging system 100 includes an imaging device mount 120 and a motorized device 106. The first and the second imaging devices 102, 103 are interconnected to the imaging device mount 120. As used herein an “imaging device mount” is a device adapted to support at least one imaging device. The imaging device mount 120 is interconnected to the motorized device 106. The motorized device 106 is operable to move the position of the imaging device mount 120, thereby changing the imaging positions of the first and the second imaging devices 102, 103. As used herein, a “motorized device” is a device adapted to manipulate the position of an imaging device mount using one or more motors. In one embodiment, the motorized device may comprise one or more motors (e.g., servo motor(s), DC current motor(s), among others) interconnected to at least one imaging device mount and adapted to position (e.g., rotationally position) at least one imaging device, thereby changing its imaging position. As used herein, “imaging position” is the position of an imaging device relative to an imaging target. A change in the imaging position of an imaging device may produce a corresponding change in the position of the imaging axis of the imaging device.

One specific imaging device mount 120 is illustrated in FIG. 3. In the illustrated embodiment, the imaging device mount 120 comprises an upper bracket 122 joined about an upper pivot 126 to a lower bracket 124. The first imaging device 102 and the second imaging device 103 may be mounted to the upper bracket 122. The lower bracket may be fixed to a stable base (not illustrated) via a lower pivot 128. The imaging positions of the first and second imaging devices 102, 103 may be adjusted rotationally in a vertical plane via rotation of the upper bracket 122 about the upper pivot 126. The imaging positions of the first and second imaging devices 102, 103 may be adjusted rotationally in a horizontal plane via rotation of the lower bracket 124 about the lower pivot 128. The motorized device 106 may be operable to facilitate such rotational adjustments of the imaging positions of the first and second imaging devices 102, 103. For example, the motorized device 106 may comprise a first motor adapted to rotationally adjust the position of the upper bracket 122 about the upper pivot 126 and a second motor adapted to rotationally adjust the position of lower bracket 124 about the lower pivot 128.

As noted above, the imaging target 8 is associated with the aluminum electrolysis cell 10. As used herein, an “imaging target” is the target at which the first and second imaging devices are aimed so as to produce a stereoscopic image of that target. As used herein, an “aluminum electrolysis cell” (sometimes referred to herein as an “aluminum electrolysis pot”) is a container containing an electrolyte (e.g., cryolite) through which an externally generated electric current is passed via a system of electrodes (e.g., an anode and a cathode) in order to change the composition of an aluminum compound (e.g., Al2O3) into pure aluminum metal (Al). In one embodiment, the imaging target 8 may be at least a portion of one or more of an old anode, a new anode, an anode stem, the crust of the aluminum electrolysis cell 10, and the tools of a PTM, among others. In one embodiment, the imaging target 8 may comprise a portion of a PTM performing one or more pot tending operations associated with the aluminum electrolysis cell 10. The location of the imaging target 8 may be adjusted, for example, by adjusting the imaging positions of at least one of the first and second imaging devices 102, 103, depending on the stereoscopic image(s) desired. For example, to facilitate breaking the crust the of the aluminum electrolysis cell 10, the imaging target 8 may be adjusted to include a portion of the crust. Similarly, to facilitate the removal of an old anode, the imaging target 8 may be adjusted to include the stem of the old anode.

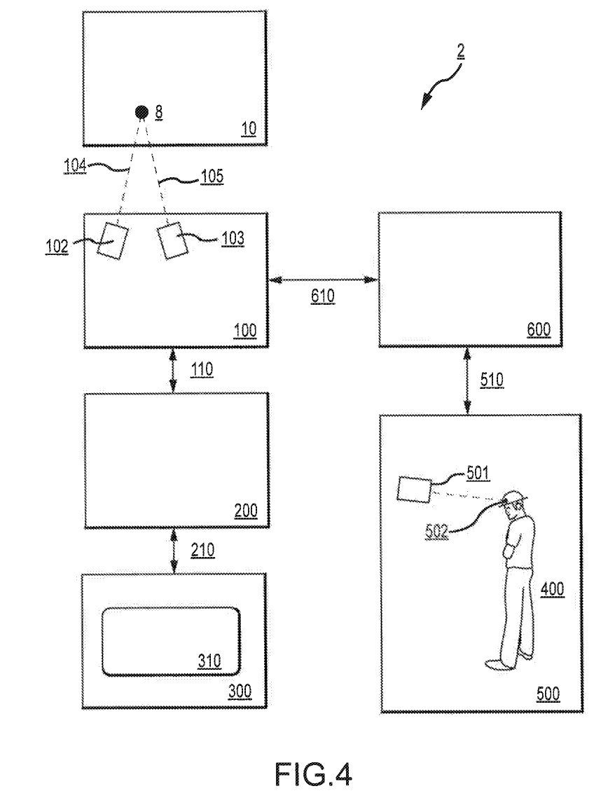

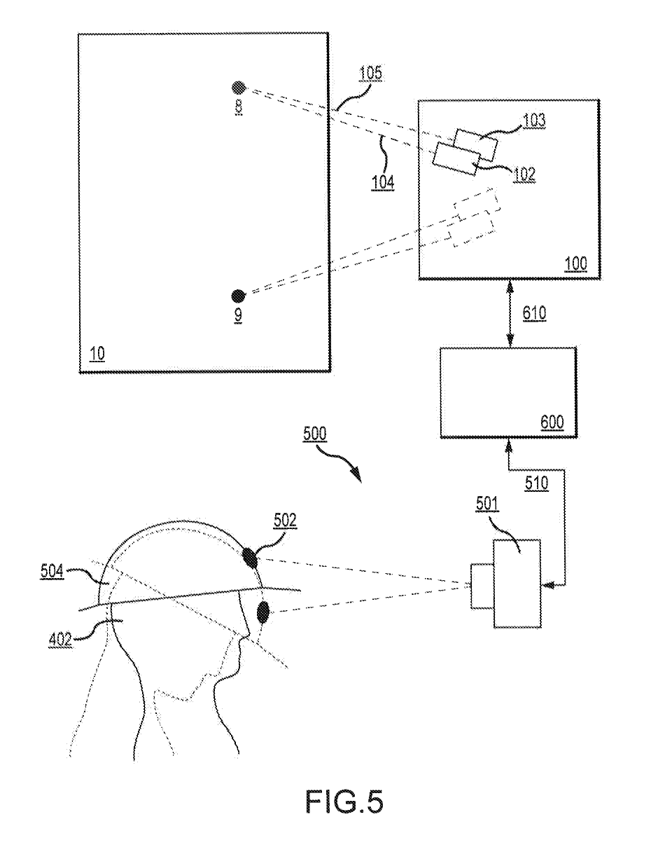

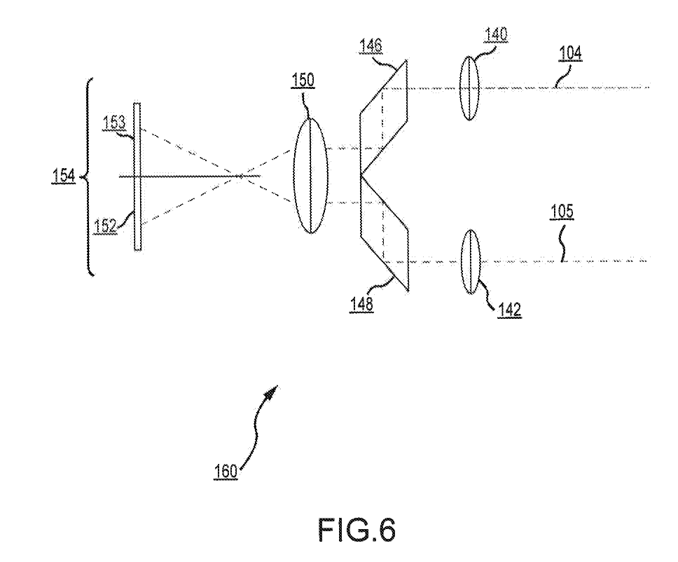

While the above embodiments generally use separate imaging devices, a single imaging device may be used to produce stereoscopic image(s). For example, and as illustrated in FIG. 6, a first imaging device may be integral to a second imaging device. In this example, a single camera includes a plurality of lenses (i.e., a single camera comprises both the first and second imaging devices). In the illustrated embodiment, a stereoscopic camera 160 may comprise a left lens 140 having a first imaging axis 104, and a left prism 146. The stereoscopic camera 160 may also comprise a right lens 142 having a second imaging axis 105, and a right prism 148. The stereoscopic camera 160 may also comprise a main lens 150 and a single light, sensing surface 154 divided into a first light sensing surface 152 and a second light sensing surface 153. A first image may be obtained by the left lens 140 and may be directed onto the light sensing surface 152 via left prism 146 and main lens 150. A second image may be obtained by the right lens 142 and may be directed onto the light sensing surface 153 via right prism 148 and main lens 150. The first and second images may be transmitted to the image processor 200 via electronic communication. The image processor 200, as discussed above, may then produce stereoscopic image(s) 310 based at least in part on the first and second images. Referring now to FIGS. 4 and 5, one embodiment of a system 2 for producing stereoscopic images to facilitate the operation and/or maintenance of aluminum electrolysis cells is illustrated. The illustrated system 2 comprises an aluminum electrolysis cell 10, an imaging target 8 associated with the aluminum electrolysis cell 10, an imaging system 100, an image processor 200, and a display device 300, as described above, the system 2 further comprising an operator 400, a body tracking system 500, and a controller 600. The body tracking system 500 is in electronic communication 510 with the controller 600, and the controller 600 is in electronic communication 610 with the imaging system 100.

The body tracking system 500 is adapted to detect body positions of the operator 400 and produce body position information. As used herein, “body position information” is information related to one or more position(s) of one or more body pails of an operator. As used herein, an “operator” is a person who works with aluminum electrolysis cells. Body position information may comprise information related to movement of a body part. Body parts useful for producing body position information include the head and appendages (e.g., arms, hands, fingers, legs, and feet to name a few). In one embodiment, body position information may be related to the orientation of the head of the operator 400.

In the illustrated embodiment of FIG. 5, the body tracking system 500 comprises a camera 501 and a tracking marker 502 associated with a body part of an operator 400. The camera 501 may be adapted to detect the orientation of the tracking marker 502 and thereby produce body position information related to the orientation of the operator's head 402. In one embodiment, the camera 501 is an infrared camera and the tracking marker 502 is a dot applied to a hard hat 504 worn by the operator 400. In one embodiment (not illustrated), the body tracking system 500 may comprise the display device 300. For example, the body tracking system 500 may include a virtual reality helmet adapted to detect the orientation of the operator's head 402 and concurrently display the stereoscopic image(s) 310 to the operator 400. In one embodiment, the body tracking system 500 may be a separate component of the system. In one embodiment, the body tracking system 500 may comprise the controller 600 and/or the display device 300.

The controller 600 is operable to receive, via electronic, communication 510, body position information from the body tracking system 500 and produce one or more control signal(s) (herein after “control signal(s)”). As used herein, “control signal(s)” are any electronic communication adapted to control an imaging system. In one embodiment, control signal(s) are electronic communication adapted to control a motor. In other embodiments, control signal(s) are electronic communication adapted to control the focus of an imaging device, or adapted to control the field of view of an imaging device, among others. In one embodiment, controller 600 may be a separate component of the system. In one embodiment, the controller 600 may comprise the body tracking system 500 and/or the imaging system 100.

As noted above, the controller 600 is in electronic communication 610 with the imaging system 100. The imaging system 100 may be adapted to respond to control signals(s) received from the controller 600. In one embodiment, the imaging system 100 comprises the controller. In one embodiment, the motorized device 106 may be adapted to move the imaging device mount 120 in response to control signals(s), and thereby move at least the first imaging device 102 from a first imaging position to a second imaging position. The first imaging position may be associated with a first body position of the operator, and the second imaging position may be associated with a second body position of the operator.

In one embodiment, and as illustrated in FIG. 5, the body part may be the operator's head 402. The operator's head 402 may move from a first head position to a second head position, causing the tracking marker 502 associated with the operator's hard hat 504 to move from a first tracking position to a second tracking position. The camera 501 may detect the first and the second positions of the tracking marker 502 and communicate body tracking information related to the movement of the operator's head to the controller 600. In response to the body tracking information, the controller 600 may communicate control signal(s) to the imaging system 100. The control signal(s) may be adapted to control the motorized device to correspondingly move the imaging device mount 120, thereby moving the first imaging device 102 from a first imaging position to a second imaging position and moving the second imaging device 103 from third imaging position to a fourth imaging position, wherein the first and third imaging positions are associated with the first head position and the second and forth imaging positions are associated with the second head position. The change in imaging positions of the first and second imaging devices 102, 103 may cause the intersection of the first and second imaging axes 104, 105 to move from a first imaging target 8 to a second imaging target 9. Thus, the stereoscopic display 300 may first display stereoscopic image(s) 310 of the first imaging target 8 and second display stereoscopic image(s) 310 of the second imaging target 9. In another embodiment, the body part may be associated with an appendage of the operator such as arm, hand, finger, leg, or foot of an operator, for example.

The body tracking system 500 may also/alternatively be used to change the field of view. As used herein, “field of view” is the area from which an imaging device obtains an image. In one embodiment, narrowing the field of view of the imaging device, or “zooming in,” is associated with a corresponding magnification of the image such that the image, as viewed by the operator, retains the same outer dimensions. In another embodiment, broadening the field of view of the imaging device, or “zooming out” is associated with a corresponding reduction of the image such that the image, as viewed by the operator, retains the same outer dimensions. In one embodiment, the field of view may change while the imaging position remains unchanged. In one embodiment, the operator's appendage (e.g., a hand) may move from a first appendage position to a second appendage position. The camera 501 may detect the first and the second appendage positions and communicate body tracking information related to the movement of the operator's appendage to the controller 600. In response to the body tracking information, the controller 600 may communicate control signal(s) to the imaging system 100. The control signal(s) may be adapted to control the field of view of at least one of the first and second imaging devices 102, 103.

As may be appreciated, any of the above components may be integrated, if appropriate. For example, and referring now to FIGS. 1 and 4, the image processor 200 may be integral with the imaging system 100, or may be a separate component. For example, the image processor 200 may be integral with one or both of the first and second imaging devices 102, 103. Likewise, the image processor 200 may be integral with the display device 300. Similarly, the image processor 200 may be integral with the body tracking device 500. Furthermore, the image processor 200 may be integral with the controller 600. In other words, the image processor 200 may be integral with the imaging system 100 and/or the display device 300 and/or the body tracking device 500 and/or the controller 600. Likewise, the display device 300 may be integral with the image processor 200 and/or the body tracking device 500 and/or the controller 600. The body tracking device 500 may be integral with the image processor 200 and/or the display device 300 and/or the controller 600. The controller 600 may be integral with the imaging system 100 and/or the image processor 200 and/or the display device 300 and/or the body tracking device 500. The imaging system 100 may be integral with the image processor 200 and/or the controller 600.

While various embodiments of the present disclosure have been described in detail, it is apparent that modifications and adaptations of those embodiments will occur to those skilled in the art. However, it is to be expressly understood that such modifications and adaptations are within the spirit and scope of the present disclosure.

What is claimed is:

1. A method comprising:
(a) passing electric current from an anode to a cathode via a molten bath in an aluminum electrolysis pot, thereby producing aluminum metal in the electrolysis pot;
(b) performing at least one pot tending operation in the aluminum electrolysis pot;
(c) obtaining images of the performing step (b) via an imaging system;
wherein the obtaining step (e) comprises:
(i) first obtaining a first image of the pot tending operation via a first imaging device aimed at an imaging target, wherein the first imaging device has a first imaging axis contained in a first vertical plane;
(ii) second obtaining a second image of the pot tending operation via a second imaging device aimed at the imaging target, wherein the second imaging device has a second imaging axis contained in a second vertical plane;
(iii) wherein the first and second vertical planes intersect proximal the imaging target;
(iv) wherein the angle between the first vertical plane and the second vertical plane is between 0.01 degrees and 10 degrees; and
(d) producing, in response to the obtaining step (c), a stereoscopic image, based at least in part on the first and the second images.

2. The method of claim 1, wherein the pot tending operation comprises removing the anode from the aluminum electrolysis pot.

3. The method of claim 1, wherein the pot tending operation comprises breaking the crust of the aluminum electrolysis pot.

4. The method of claim 1, wherein the pot tending operation comprises raising the anode out of the molten bath of the aluminum electrolysis pot.

5. The method of claim 1, wherein the anode is a first anode, and wherein the pot tending operation comprises removing the first anode; inserting a second anode; and covering the second anode with alumina.

6. The method of claim 1, wherein the producing step (d) comprises displaying the images on a display for viewing by the operator.

7. The method of claim 1, further comprising:
moving at least the first imaging device of the imaging system from a first imaging position to a second imaging position to facilitate the obtaining step (c), wherein the first imaging position is associated with a first body position of an operator, and wherein the second imaging position is associated with a second body position of the operator.

8. The method of claim 1, further comprising:
moving the first imaging device from a first imaging position to a second imaging position; and
moving the second imaging device from a third imaging position to a forth imaging position to facilitate the obtaining step (c), wherein the first and third imaging positions are associated with a first body position of an operator, and wherein the second and fourth imaging positions are associated with a second body position of the operator.

9. The method of claim 7, further comprising:
changing the field of view of at least the first imaging device from a first field of view to a second field of view to facilitate, the obtaining step (c).

10. The method of claim 9, wherein the first field of view is associated with a third body position of an operator, and wherein the second field of view is associated with a fourth body position of the operator.

11. The method of claim 7, wherein the moving step comprises translating the imaging device in at least one of an x, y, and z direction.

12. The method of claim 7 wherein the moving step comprises rotating the imaging device about an axis.

13. The method of claim 7, wherein the moving step is a second moving step, the method comprising:
first moving a body part of the operator from the first body position to the second body position;
detecting the first and second body positions via a body tracking system;
producing body position information in response to the detecting step;
communicating the body position information to a controller associated with the imaging system; and
completing the second moving step.

14. The method of claim 13, wherein the body part is the head of the operator.

15. The method of claim 13, wherein the producing step (d) comprises:
displaying the stereoscopic image on a display for viewing by the operator, wherein the display is a part of the body tracking device.

16. The method of claim 1, wherein the first imaging device is integral to the second imaging device.

17. A system comprising:
(a) an imaging system comprising:
(i) a first imaging device operable to obtain a first image of a pot tending operation, wherein the first imaging device has a first imaging axis contained in first vertical plane; and
(ii) a second imaging device operable to obtain a second image of at least a portion of the aluminum electrolysis pot, wherein the second imaging device has a second imaging axis contained in a second vertical plane;
(iii) wherein the first and second vertical planes intersect proximal an imaging target;
(iv) wherein the angle between the first vertical plane and the second vertical plane is between 0.01 degrees and 10 degrees; and
(b) an image processor, in electronic communication with the imaging system, wherein the imaging system is operable to produce a stereoscopic image, based at least in part on the first and the second images.

18. The system of claim 17, wherein the first imaging device is integral to the second imaging device.

19. The system of claim 17, further comprising:
a display device, in electronic communication with the image processor, operable to display the stereoscopic image to an operator.

20. The system of claim 17, further comprising:
a body tracking system adapted to detect body positions of an operator, and produce corresponding body position information;
a controller, in electronic communication with the body tracking system, wherein the controller is operable to produce control signals in response to the body position information;
and wherein the imaging system (a) further comprises:
(i) an imaging device mount, interconnected to at least the first imaging device, wherein the imaging device mount is moveable; and
(ii) a motorized device interconnected to the imaging device mount and in electronic communication with the controller, wherein the motorized device is adapted to move the mount in response to the control signals, and thereby move at least the first imaging device from a first imaging position to a second imaging position, wherein the first imaging position is associated with a first body position of the operator, and wherein the second imaging position is associated with a second body position of the operator.

21. The system of claim 20, further comprising a display device, in electronic communication with the image processor, wherein the display device is a part of the body tracking device.

22. A system comprising:
(a) an imaging system comprising:
(i) a first imaging device operable to obtain a first image of a pot tending operation, wherein the first imaging device has a first imaging axis contained in first vertical plane; and
(ii) a second imaging device operable to obtain a second image of at least a portion of the aluminum electrolysis pot, wherein the second imaging device has a second imaging axis contained in a second vertical plane;
(iii) wherein the first vertical plane is parallel to the second vertical plane; and
(b) an image processor, in electronic communication with the imaging system, wherein the imaging system is operable to produce a stereoscopic image, based at least in part on the first and the second images.

23. A method comprising:
(a) passing electric current from an anode to a cathode via a molten bath in an aluminum electrolysis pot, thereby producing aluminum metal in the aluminum electrolysis pot;
(b) performing at least one pot tending operation in the aluminum electrolysis pot;
(c) obtaining images of the performing step (b) via an imaging system; wherein the obtaining step (c) comprises:
(i) first obtaining a first image of the pot tending operation via a first imaging device aimed at an imaging target, wherein the first imaging device has a first imaging axis contained in a first vertical plane;
(ii) second obtaining a second image of the pot tending operation via a second imaging device aimed at the imaging target, wherein the second imaging device has a second imaging axis contained in a second vertical plane;
(iii) wherein the first vertical plane is parallel to the second vertical plane; and
(d) producing, in response to the obtaining step (c), a stereoscopic image, based at least in part on the first and the second images.
